(19) United States
(12) Patent Application Publication
(10) Pub. No.: US 2006/0172052 A1
(43) Pub. Date: Aug. 3, 2006

(54) Edible product comprising flavoring microcapsules

(76) Inventors: Alexander Hahn, Singapore (SG); Gil Trophardy, Gex (FR)

Correspondence Address: WINSTON & STRAWN LLP, 1700 K STREET, N.W., WASHINGTON, DC, 20006, US

(21) Appl. No.: 11/371,812

(22) Filed: Mar. 8, 2006

Related U.S. Application Data
(63) Continuation of application No. PCT/IB05/00018, filed on Jan. 3, 2005.

(30) Foreign Application Priority Data
Jan. 12, 2004 (EP) 04100069.6

(51) Int. Cl. A23L 1/22

(52) U.S. Cl. 426/534

(57) ABSTRACT

Edible products that include a flavoring delivery system in the form of microbial microcapsules enclosing a flavor ingredient or composition. The edible products of the invention are prepared by a process that includes a thermal treatment at high temperature of an edible composition that incorporates the flavoring delivery system.

### CROSS-REFERENCE TO RELATED APPLICATIONS

This application is a continuation of International application PCT/IB2005/000018 filed Jan. 3, 2005, the entire content of which is expressly incorporated herein by reference thereto.

### TECHNICAL FIELD

The present invention relates to the food industry. It concerns more particularly a food product comprising a flavoring delivery system in the form of microbial microcapsules. The edible product of the invention is characterized by the fact that during its processing, an edible composition comprising the flavoring delivery system has been subjected to a thermal treatment at high temperatures. Unexpectedly, this processing allows to obtain a product wherein, instead of the expected deterioration or loss of the flavor, the encapsulated flavor provides to the product particularly appreciated organoleptic impact and tonalities.

### BACKGROUND

Encapsulated systems wherein micro-organisms are used as encapsulating materials for protecting various kind of labile active ingredients have been widely disclosed in the prior art. JP 5-253464, JP 7-289885, JP 8-243378, EP 085805, EP 453316 or EP 242135 describe yeast microcapsules encapsulating various kinds of actives such as fatty acids, phospholipids, long chain hydrophobic liquids, or fragrances and flavors. The known methods for producing microbially encapsulated materials usually comprise mixing a microbe such as fungus, bacterium or alga with a liquid material to be encapsulated and water to form an emulsion, and maintaining a mixing so that the liquid material to be encapsulated is absorbed by diffusion across the microbial cell wall and then retained within the microbe. The systems disclosed are essentially made of a microbial cell and an active substance to be encapsulated. However, it appeared that in the food industry, the organoleptic properties, the stability and the yield of the products flavored with this type of microbial microcapsules, were not totally satisfying and could thus still be improved.

More recently, WO 03/041509 disclosed microbial microcapsules enclosing an exogenous material, the capsules being described as presenting an improved velocity, strength and sustainment of the release of the exogenous material there-encapsulated. In the described systems, whole or a part of the surface of the micro-organisms (capsules) is coated with at least one kind of material that has been chosen from the group that consists of saccharides, sweeteners with a high sweetness, proteins and polyhydric alcohols. Preferably, the micro-organisms used have been subjected to an elution, i.e. the endogenous intramycelial components have been eluted before encapsulating the exogenous material. The systems described are used in applications that are held in the oral cavity during a long time, in particular in gums such as chewing gums, soft candies and mastication agents. Although other applications than chewing gums are mentioned in a general manner, no examples are given. Furthermore, it is specified in the document that when the microcapsules enclose exogenous materials that are easily negatively influenced by heat, such as flavor components, the capsules have to be added, during processing of edible products, close to the end of the production process, in order to prevent degeneration of the exogenous material by heating. In other words, the document teaches that microbial systems cannot be used in applications wherein they would be subjected to a thermal treatment at high temperatures, as they would degenerate. Accordingly, the examples of preparation of chewing gums described in the application specify that the microbial capsules have been added at the end of the process.

Now, in a totally unexpected manner in view of the teaching of the prior art, we have been able to prepare edible products wherein microbial cell microcapsules encapsulating flavoring ingredients or compositions have been used and subjected to high temperatures during the processing of edible compositions comprising the capsules. These systems have unexpectedly proved to show a heat stability and provide particularly good organoleptic properties.

### SUMMARY OF THE INVENTION

The present invention thus relates to an edible product including flavoring microcapsules formed of an encapsulated flavor ingredient or composition and an encapsulating material comprising a micro-organism and at least one carbohydrate material, the edible product being characterized in that it has been prepared by a process wherein an edible composition comprising the microcapsules has been subjected to a thermal treatment at a temperature of at least 70° C. In a second embodiment of the invention, the edible product is prepared by the processing of an edible composition comprising among other ingredients microcapsules encapsulating a flavor ingredient or composition, wherein a heat treatment at a temperature of at least 100° C. is performed. A third embodiment concerns an edible product prepared by the processing of an edible composition comprising microcapsules, which processing comprises a thermal treatment at a temperature higher than 170° C.

Contrary to what could have been expected in view of the prior art teaching, the products of the invention proved to be particularly appreciated in terms of flavor tonality and flavor impact. In particular, compared with products flavored with a typical spray-dried flavored powder, as shown in the examples below, the products of the invention showed similar or sometimes even better flavoring properties. It therefore appeared that, instead of deteriorating the flavor encapsulated in the microcapsules, the thermal treatment enhances the flavor stability in the final application as demonstrated by the quality of the flavor impact as well as the perception of some tonalities in the final applications. Therefore, the encapsulated system withstands the heat treatment.

### BRIEF DESCRIPTION OF THE DRAWINGS

FIGS. 1a) to 1d) show on bar diagrams results of the evaluation of beef flavored French fries.

FIGS. 2a) to 2d) show on bar diagrams results of the evaluation of garlic flavored crackers.

FIGS. 3a) to 3d) show on bar diagrams results of the evaluation of mixed herbs flavored fresh pasta.

Figures

### DETAILED DESCRIPTION OF THE PREFERRED EMBODIMENTS

The edible product object of the invention results from the processing of an edible composition comprising microcapsules formed of an encapsulated flavor ingredient or composition and an encapsulating material.

The encapsulating material according to the present invention comprises a micro-organism and at least one carbohydrate material. Micro-organisms suitable for the purpose of the invention include yeasts, bacteria or fungi. However, these micro-organisms are given by way of example and are not limiting the invention. The encapsulating material enclosing the active flavor further comprises at least one carbohydrate material. The latter material is added at a late stage of the process of preparation of the microcapsules as described below. The addition of a carbohydrate carrier material in this process allows to retain more flavor ingredient or composition in the delivery system or encapsulated system provided, avoiding the need for a centrifugation step as it was the case in previously described processes such as described in EP 242135.

As regards the carbohydrate material suitable for the purpose of the invention, native starches such as corn, rice, tapioca, potato, wheat and other cereal and polysaccharide sources; chemically modified starches such as starch ethers, starch esters, crosslinked starches, oxidized starches; physically modified starches such as mechanically damaged, extruded, dextrinised, or pre-gelatinized and thin boiling starches; or enzymatic and acid hydrolyzed starches such as low dextrose equivalent (DE) maltodextrins, maltodextrin with DE below 20 and finally glucose syrup with DE above 20 can be used. Mono, di or polysaccharides may also be used as encapsulating materials for microbial microcapsules. These film former materials are given by way of example but should not be considered as limiting the invention.

It is clear that the carbohydrate material forms, together with the micro-organism, a distinct part of the encapsulating material of the microcapsules of the present invention. The carbohydrate material has thus to be differentiated from the carbohydrates possibly present in the micro-organism itself, for example the carbohydrates present in the cell wall of the micro-organism. Therefore, in an embodiment of the edible product of the present invention, the carbohydrate material is added carbohydrate material, which is separate from carbohydrates originating from the micro-organism.

The carrier or encapsulating material is used in a proportion varying between 50 and 95% by weight relative to the total weight of the microcapsule. Preferably, the amount used is comprised between 70 and 90% by weight.

Besides a micro-organism and at least one carbohydrate material, the encapsulating material can contain optional ingredients, the purpose of which is for instance to enhance the retention of the flavor. In particular, proteins can be used in proportions varying between 1 and 5% by weight relative to the total weight of the microcapsule. Examples of proteins suitable for this purpose include gelatin (with high and low bloom), plant proteins and fractions thereof, casein protein, whey protein, whey and corn protein and fraction thereof. Gums constitute another type of additional ingredient that can be added to the encapsulating material forming the microcapsules present in the edible product of the invention. These gums are used in proportions varying between 0.1 and 2% by weight relative to the total dry weight of the microcapsule and include pectin, xanthan, agar, algae gum (like alginates, carrageenans, Furcellarm and other), gum ghatti, gum traganth, gum guar, cellulose and derivatives thereof, microbial dextran and pullulan. This list of gums is given by way of example and is not limiting the invention.

The encapsulating material above-described encloses a flavor ingredient or composition. The terms “flavor ingredient or composition” as used herein are deemed to define a variety of flavor ingredients or compositions of current use in the food industry, of both natural and synthetic origin. They include single compounds and mixtures. The microcapsules used in the invention can encapsulate volatile or labile ingredients in liquid form, preferably with a log P comprised between −2 and 7. Specific examples of such components may be found in the current literature, e.g. in Fenaroli's Handbook of flavor ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). These substances are well known to a person skilled in the art of flavoring or aromatizing consumer products, i.e. of imparting an odor or a flavor or taste to a consumer product traditionally flavored, or of modifying the taste of the consumer product. Natural extracts can also be encapsulated into the system flavoring the products of the invention. These include citrus extracts such as lemon, orange, lime, grapefruit, or mandarin oils or coffee, tea, mint, cocoa, vanilla or essential oils of herbs and spices between other.

The proportion of flavor ingredient or composition in the microcapsule is typically comprised between 5 and 50% by weight and preferably between 10 and 30% by weight relative to the total weight of a capsule.

Processes for the preparation of the microcapsules used in the composition of the edible product of the present invention, are described in documents from the prior art such as in EP 242135, EP 453316 or EP 085805. These processes all comprise mixing a microbe with a liquid form of the encapsulatable material in the presence of an aqueous medium such that the liquid flavor forms an emulsion in the aqueous medium in order to attain good dispersion and contact of the microbe with the flavor which can be according to some processes dissolved in a lipid-extending substance. The liquid flavor to be encapsulated may be mixed with a washed microbe or an aqueous paste or slurry of the microbe, or the encapsulatable flavor in a small quantity of water, may be mixed with the dry microbe. Only a small quantity of aqueous medium may be employed. In so doing, the liquid flavor diffuses into the micro-organism and will be retained within the cell walls or microbe-capsule of the micro-organism.

Therefore, in an embodiment, of the edible product of the present invention, the micro-organism has an intact cell-wall and the flavor ingredient is at least partially encapsulated within the intact cell wall. The term “at least partially”, in the context of the present invention, refers to the fact that preferably hydrophobic flavors will diffuse and accumulate into the micro-organism. Less hydrophobic or hydrophilic flavors, in contrast, where observed to only partially diffuse into the lumen within the cell-wall of the micro-organism.

In particular embodiments, the elution of intracellular components to the outside of yeast cells may be accomplished as described in EP 453316.

Examples of suitable treatment mixing operations to produce and maintain the aqueous emulsion are low-shear mixing and orbital shaking, for instance at 180 rpm. Prior emulsification of the encapsulatable liquid flavor is not needed.

The treatment may be performed at normal ambient temperature but preferably the temperature is elevated, at least during the initial stage of the treatment, such as during at least the first 30 min, or in order to expedite the treatment. A suitable elevated temperature may be in the range of 35 to 60° C.

The treatment is continued for a few hours until encapsulation may be observed microscopically as one or more globules of the materials are inside the microbial cell.

At this stage of the encapsulation process (between about 30 min and 16 hours), at least one carbohydrate material is added to the encapsulation mixture and mixed for about 5 to 30 min until homogeneous. The sample then obtained is subjected to a spray-drying. Advantageously in this embodiment of the encapsulation process, the separation and washing steps necessary in the process described in EP 242135 are no longer useful. The carbohydrate material thus forms a layer around the micro-organism enclosing the flavor ingredient and thus further encapsulates the flavored ingredient.

The microcapsules prepared as described above have a mean diameter in the range of mean diameter in the range of 5 μm to 2 mm. Preferably, the diameter is in the range of 40μm to 1 mm, more preferably 60μm to 500 μm. The term mean refers to the arithmetic mean.

In an embodiment of the present invention, the microcapsules prepared as described above are used for flavoring edible products of the present invention in proportions varying from 0.01 to 2% depending on the edible product and the organoleptic effect it is desired to achieve.

More particularly, the microcapsules are part of an edible composition which is going to be processed into the edible product of the present invention. A detailed description of the other ingredients present in the edible composition is not necessary here, as these ingredients are as varied as the nature of the edible products that can be prepared within the framework of the invention. By way of examples, the edible products object of the present invention include applications in high water activity such as soups; baked products such as crackers, bread, cakes; high boiled applications such as fresh and dry pasta; and cereal flakes, extruded snacks, fried products such as French fries or fabricated potato chips. A skilled person in the art, namely a food technologist, is able to choose the ingredients required to prepare an edible base flavored by means of the above-described flavoring system, to be processed into final consumer products.

The edible products covered by the present invention have in common the fact that the processing of the corresponding starting edible compositions includes a thermal treatment, at a temperature of at least 70° C., respectively at least 100° C. or at least 170° C., and in that the flavoring microcapsules above-described are added to the edible compositions to be processed into these products before the thermal treatment.

Food processing technologies which include a thermal treatment at high temperatures are numerous. The skilled person in the art, knows well all these types of processes. By way of example of such processes, there can be cited a retort processing, including a heat treatment by which an edible composition is subjected to temperatures of 100 to 140° C. for a period of 1 s to 20 min (depending on the temperature applied and type of food). A lozenges process is another example of a process suitable for preparing products of the invention. In the latter, sugar and gum solution are mixed. This paste is formed into a dough, cut into pieces. These pieces are tried with hot air in tunnel at 70° C. to 190° C. for 1 to 60 min. Another example is the preparation of cereal based products such as Corn Flakes™ which includes pressure cooked corn grits which are flaked and toasted. On the other hand, extrusion processes for the preparation of extruded snacks, wherein corn grits are extruded at temperatures ranging from 90 to 200° C.; or preparation of baked products which are baked at 150 to 240° C. air temperature; or preparation of dry pasta wherein wheat flour and egg and additional cereal and protein sources are mixed and then extruded into desired shapes, constitute other examples. These wet pasta products are then dried at 70 to 140° C. for 1 to 8 hours.

All these processes are given as examples, but the invention also covers other food processings wherein high temperature conditions are used. All these processes are performed on edible compositions which comprise the microbial microcapsules defined above, contrary to the prior art wherein the capsules had to be added at the end of the processing to avoid the exposure to high temperatures. As shown in the examples below, the edible products of the present invention proved to be very efficient with regard to the flavor impact and tonalities.

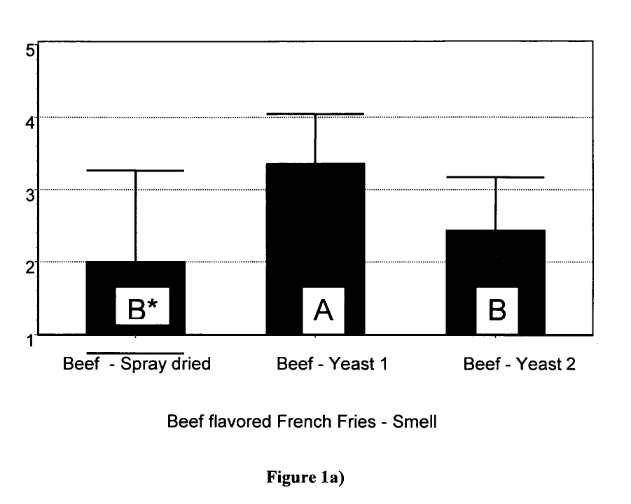

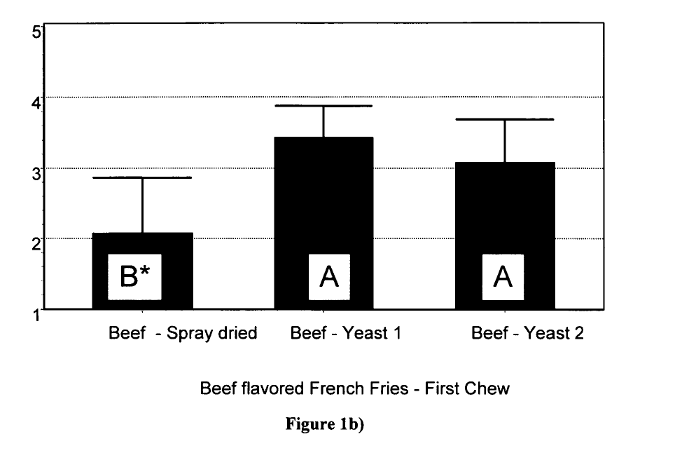

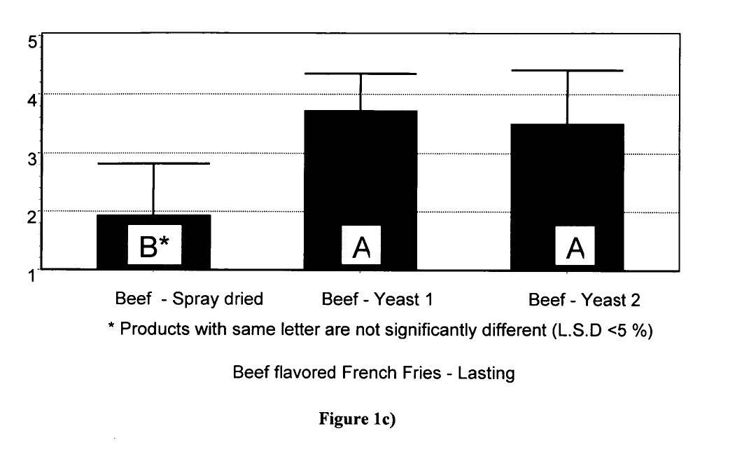

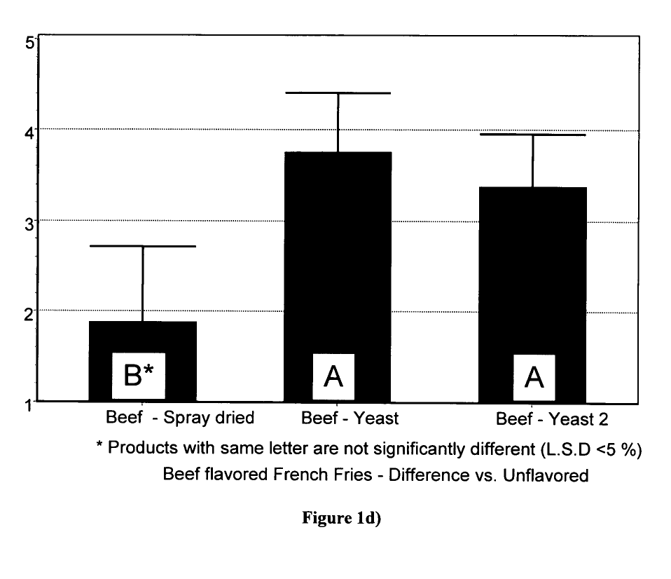

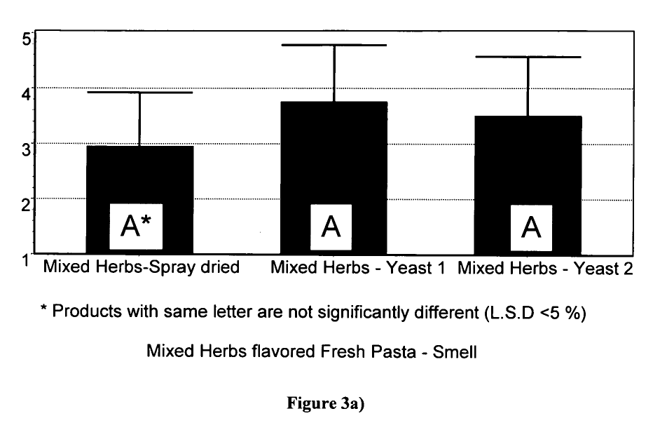

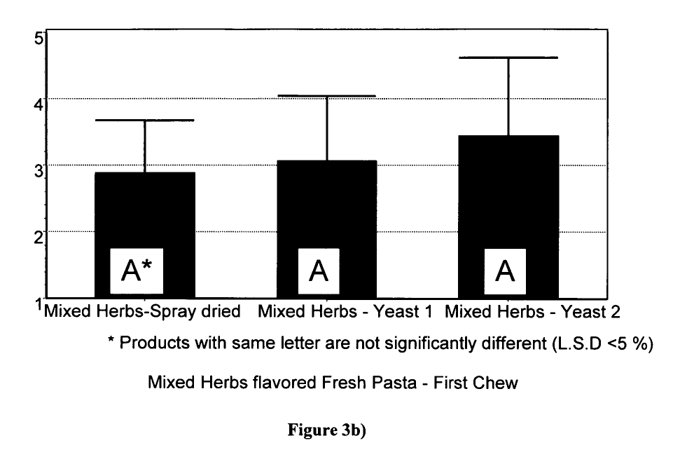

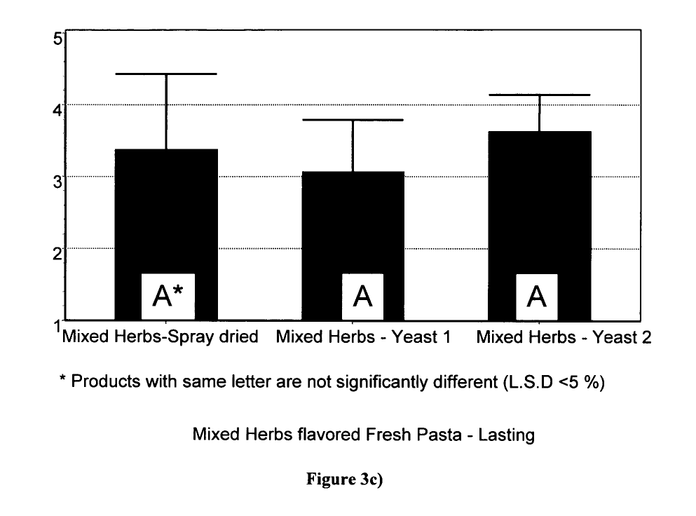

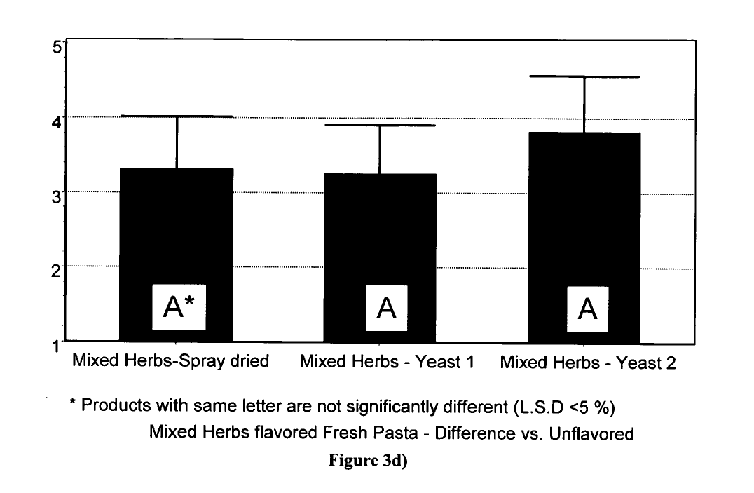

More particularly, FIGS. 1, 2 and 3 describe the results of a sensorial panel performed over 8 trained panelists who were asked to evaluate, on a blind test, 3 samples for every test namely 2 products according to the present invention (flavored with various types of microcapsules) and 1 product flavored with a spray-dried powder. The figures give the results of their evaluations through the following parameters : a) smell ; b) impact after first chew; c) lasting after swallowing and d) difference with an unflavored sample. Scores form 1 (weak) to 5 (strong) were given.

### EXAMPLES

The invention will now be described in a more detailed manner in the following examples wherein the temperatures are indicated in degrees Celsius and the abbreviations have the usual meaning in the art.

### Example 1

French Fries

Preparation of Flavoring Delivery Systems

Preparation of Delivery Systems According to the Invention

Composition

| Ingredients | % dry weight |
|---|---|
| Flavor¹⁾ | 20 |
| Yeast²⁾ | 40 |
| Maltodextrin | 40 |
| Total | 100 |

¹⁾beef flavor ref. 505443AH, garlic flavor ref. 905097, mixed herbs flavor ref. 700167.01T; origin: Firmenich SA, Geneva Switzerland
²⁾ethanol yeast (referred to as “yeast 1”), baker yeast (referred to as “yeast 2”)

Preparation

400 g of yeast solids were hydrated with 2200 g of water. Then 200 g of flavor were added and mixed for 4 hours at 40°. 400 g of maltodextrin were then added to the encapsulation mixture and mixed until homogeneous. The mix was then dried on a Niro Minor wheel atomizer.

Preparation of a Comparative Sample

An iso-cost product was used for the comparison, in this case there was chosen a spray-dried powder. In particular, a spray-dried powder was used first to determine a good taste level. Then, the delivery systems as defined in the present invention were dosed accordingly, based on their manufacturing cost.

Principle

The evaluations were carried out with a panel of 8 people who tested the applications in the form of a blind test. An unflavored sample was identified and used as a reference. Then eight trained panelists evaluated three samples for every test (first sample is a product flavored with yeast 1 based microcapsules; second sample is a product flavored with yeast 2 based microcapsules; third sample is a product flavored with spray-dried powder). They evaluated on a 1 (weak) to 5 (strong) scale, the smell, the impact after first chew, the lasting after swallowing and the difference with the unflavored sample.

The results have been treated by analysis of variance (ANOVA) and Fisher's least significant difference test (L.S.D) at 5% level of significance (10% in some cases).

Application in Beef Flavored French Fries

French Fries Formula:

| Ingredients | Parts by weight |
|---|---|
| Water | 60.00 |
| Salt | 1.00 |
| Basic batter | 39.00 |
| Total | 100.00 |

Dosages:

| Encapsulation | Dosage in wet batter (%) |
|---|---|
| Spray-dried system (SD) | 1.20 |
| Yeast 1 system | 1.18 |
| Yeast 2 system | 1.21 |

The encapsulated flavors (2 samples of microbial microcapsules and 1 sample of spray-dried powder) enclosing a beef flavor were added to the batter and mixed thereto before blending with water. Mixing was pursued until smooth in a Hobart mixer for 5 minutes at speed 2. The French fries were coated with the obtained batter and parfried at 180° C. for 60 s in palm oil. Fast freeze was performed. Finally reconstitution was carried out at 180° for 2.5 min in palm oil.

Results

FIGS. 1a), b), c), and d) show in bar diagrams the results of the evaluations made by the panel as regards the intensity of smell (a), impact after first chew (b), lasting after swallowing (c) and difference from unflavored (d).The products with the same letter are not significantly different.

FIG. 1a) shows that one of the products according to the invention provides the highest smell intensity. FIGS. 1b), c) and d) show that both systems of the invention are superior as regards all other parameters, to a product flavored with a spray-dried powder.

Hedonic comments show that both systems of the invention are the most appreciated, with the most authentic flavor.

Similar products were prepared with other flavor tonalities, in particular garlic, and mixed herbs. Similar results were obtained, especially concerning the long lasting effect which is really stronger in intensity with products flavored according to the invention.

### Example 2

Crackers

Principle

Delivery systems (3 samples) were prepared as described in Example 1.

Evaluations were carried out with the same principle as described in Example 1.

Application in Garlic Flavored Crackers

Cracker Formula:

| | |
|---|---|
| Ingredient | Quantity (g) |

Part 1: Raising agents

| | |
|---|---|
| Tricalcium phosphate | 0.25 |
| Sodium bicarbonate | 0.25 |
| Water | 5 |
| Ammonium bicarbonate | 2 |
| Total part 1 | 7.5 |

Part 2: Cracker dough

| | | |
|---|---|---|
| Shortening fat | 14 | |
| Sugar syrup (65%) | 1 | |
| Salt | 1 | |
| Malt extract | 2 | |
| Wheat flour | 100 | |
| Water (hot) | 30 | |
| Total part 2 | 148 | |
| Total in complete dough: | 155.5 | g |

Part 3: Coating

| | |
|---|---|
| Baked crackers | 130 |
| Palm oil | 19.5 |
| Salt | 1.3 |
| Total coating amount: | 150.8 |

Dosages:

| Encapsulation | Dosage (%) |
|---|---|
| SD | 0.35 |
| Yeast 1 system | 0.32 |
| Yeast 2 system | 0.26 |

Part 1 was blended separately. The melted shortening fat in a Hobbart was blended with part 1 and sugar syrup was added. The flour and other dry ingredients, including the encapsulated flavors were added. Hot water was added and the content was mixed for 5 to 10 min. The dough was put in a plastic bag and rolled it flat. A noodle machine was then used to roll out the dough to 2 mm. The crackers were baked at 210° C. for 5 min. An oil coating was added in a turning device. The crackers were finally put in an aluminum bag.

Results

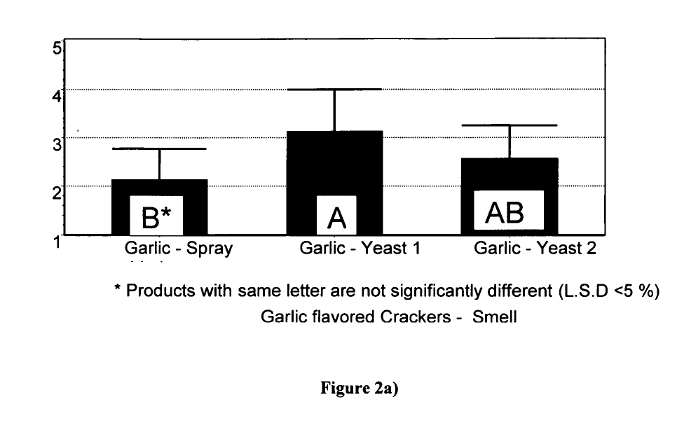

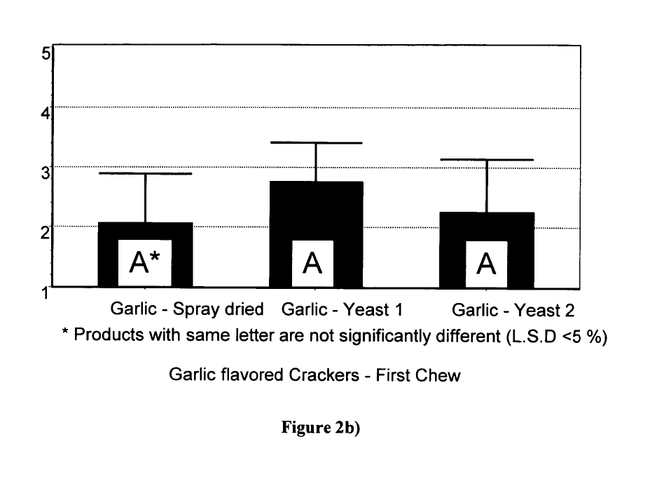

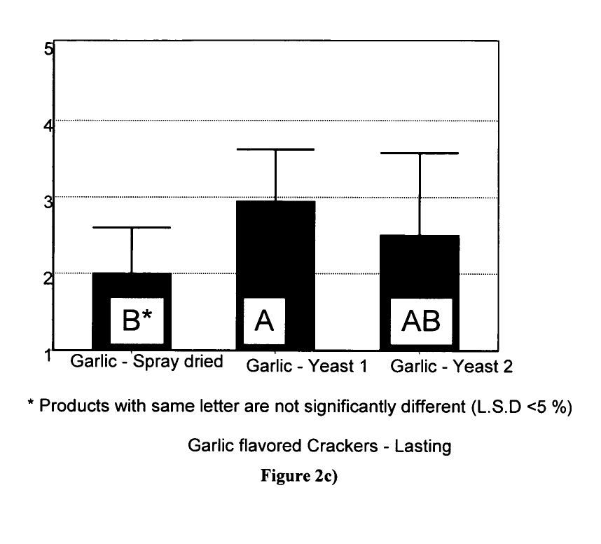

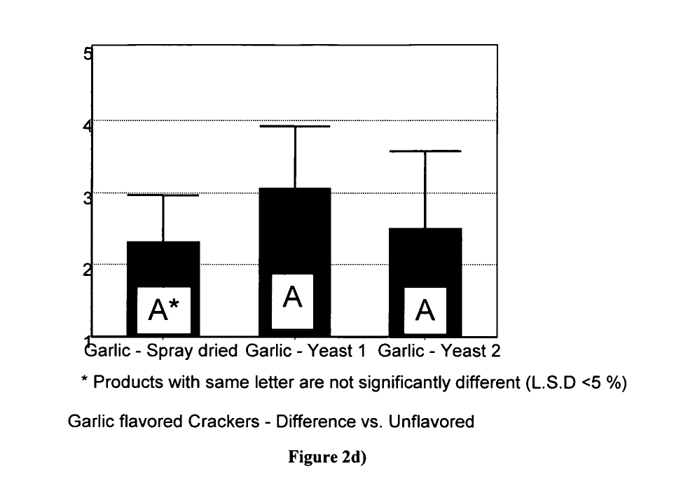

FIGS. 2a), b), c) and d) show the results for garlic flavor in bar diagrams and the results of the evaluations by the panel of the intensity of smell (a), impact after first chew (b), lasting after swallowing (c) and difference from unflavored (d).The products with the same letter are not significantly different.

The figures show that all samples were not significantly different concerning all parameters. Therefore, products flavored according to the invention perform as well as products flavored with a spray-dried powder.

Hedonic comments show both products flavored according to the invention have the most authentic flavor, one of them being the most appreciated.

### Example 3

Fresh Pasta

Principle

Delivery systems (3 samples) were prepared as described in Example 1.

Evaluations were carried out with the same principle as described in Example 1.

Application in Mixed Herbs Flavored Fresh Pasta

Pasta Dough:

| Ingredients | Parts by weight |
|---|---|
| Wheat flour 11% protein | 32.22 |
| Wheat durum | 34.47 |
| Salt | 0.58 |
| Water | 15.79 |
| Egg whole | 16.75 |
| Yeast¹⁾ | 0.20 |
| Total | 100.00 |

¹⁾gistex; origin: DSM, Holland

Dosages:

| Encapsulation | Dosage (%) |
|---|---|
| Spray-dried | 0.50 |
| Yeast 1 system | 0.50 |
| Yeast 2 system | 0.45 |

Preparation

The wheat durum was mixed with the flour. All ingredients were then added and mixed during 6 min in the Hobart at speed 2. Delivery system containing the flavor was then added and mixed for 1 min until properly dispersed. The dough was left to rest for 30 min. A noodle machine was then used to roll out this dough to 1 mm, which was finally cut into tagliatelles. Pasteurization was performed in the oven at 75° under full steam for 20 min. The product was packed and then cooked in boiling water for 2 min.

Results

FIGS. 5a), 5b), 5c), and 5d) show in bar diagrams the results of the evaluations by the panel of the intensity of smell (a), impact after first chew (b), lasting after swallowing (c) and difference from unflavored (d).The products with the same letter are not significantly different.

The figures show that all samples are not significantly different concerning all parameters. Therefore, products flavored according to the invention perform as well as products flavored with a spray-dried powder.

On the other hand, hedonic comments from the panelist outline that one of the products of the invention is clearly preferred as it was described to have to most authentic mixed herbs flavor.

What is claimed is:

1. An edible product including flavoring microcapsules formed of an encapsulated flavor ingredient or composition and an encapsulating material comprising a micro-organism and at least one carbohydrate material, the edible product being formed by subjecting an edible composition comprising the microcapsules to a thermal treatment at a temperature of at least 70° C.

2. The edible product according to claim 1, in which the micro-organism has an intact cell wall and in which the flavor ingredient is at least partially encapsulated within the intact cell wall.

3. The edible product according to claim 1, in which the carbohydrate material that is present is added carbohydrate material which is separate from carbohydrates originating from the micro-organism.

4. The edible product according to claim 1, wherein the edible composition has been subjected to a thermal treatment at temperature of at least 170° C.

5. The edible product according to claim 1, which comprises from 0.01 to 2% by weight of microcapsules.

6. The edible product according to claim 1, wherein the carbohydrate material is selected from the group consisting of starches, hydrolyzed starches, mono, di or polysaccharides and yeasts.

7. The edible product according to claim 1, in the form of a fried product, a dough based product, or a dry or fresh pasta.

8. A process for the preparation of an edible product, which comprises preparing an edible composition comprising microcapsules formed of an encapsulated flavor ingredient or composition and an encapsulating material comprising a micro-organism and at least one carbohydrate material, and subjecting the edible composition during its processing into the edible product to a thermal treatment at a temperature of at least 70° C. to enhance flavor stability and form the edible product.

9. The process according to claim 8, wherein the edible composition is subjected to a thermal treatment at a temperature of at least 100° C.

10. The process according to claim 8, wherein the edible composition is subjected to a thermal treatment at a temperature of at least 170° C.

11. An edible composition prepared by the process of claim 8.
